(19) United States
(12) Patent Application Publication
(10) Pub. No.: US 2026/0276671 A1
(43) Pub. Date: Sep. 17, 2026

(54) METHOD TO DETERMINE VEHICLE LONGITUDINAL ACCELERATION MEASUREMENT ERROR

(71) Applicants: FCA US LLC, Auburn Hills, MI (US); Stellantis Auto SAS, Poissy (FR)

(72) Inventor: Lubna S. Khasawneh, Auburn Hills, MI (US)

(21) Appl. No.: 19/079,745

(22) Filed: Mar. 14, 2025

(51) Int. Cl. G01P 21/00; G01P 15/08

(52) U.S. Cl. CPC G01P 21/00; G01P 15/08

(57) ABSTRACT

A method for estimating longitudinal acceleration in a vehicle based on a measured longitudinal acceleration from a sensor of the vehicle includes obtaining a measured longitudinal acceleration from the sensor, determining a total force as a function of vehicle mass and powertrain torque, determining a Kalman filter gain, determining an error in the measured longitudinal acceleration as a function of the Kalman filter gain and the total force, and providing an estimated longitudinal acceleration as a function of the measured longitudinal acceleration and the error. The estimated longitudinal acceleration can be provided to vehicle control systems to improve vehicle dynamic control.

### FIELD

The present disclosure relates to methods for determining an estimated longitudinal acceleration measurement error in a vehicle.

### BACKGROUND

Vehicle accelerations are measured by one or more sensors. Acceleration determinations are used in various vehicle control systems and schemes and accurate determinations can improve vehicle dynamics and control. Acceleration sensors can have a bias or offset, and can provide noisy output signals/data, whereby output from the sensor is different than the actual value of the parameter detected by the sensor. This sensor measurement error can affect performance of systems that utilize the senor outputs.

### SUMMARY

In at least some implementations, a method for estimating longitudinal acceleration in a vehicle based on a measured longitudinal acceleration from a sensor of the vehicle includes obtaining a measured longitudinal acceleration from the sensor, determining a total force as a function of vehicle mass and powertrain torque, determining a Kalman filter gain, determining an error in the measured longitudinal acceleration as a function of the Kalman filter gain and the total force, and providing an estimated longitudinal acceleration as a function of the measured longitudinal acceleration and the error. The estimated longitudinal acceleration can be provided to vehicle control systems to improve vehicle dynamic control.

In at least some implementations, the total force is determined also as a function of a wheel size.

In at least some implementations, the powertrain torque is a torque at the vehicle wheels determined as a function of an engine torque and a driveline ratio.

In at least some implementations, the total force includes a wheel force which is a longitudinal force from a wheel to a vehicle body, an aerodynamic force, a rolling resistance force and the force of gravity. In at least some implementations, the wheel force is a wheel torque divided by a wheel radius, and the wheel torque is determined as a function of the powertrain torque and a driveline ratio.

In at least some implementations, the Kalman filter gain is a 2×1 matrix obtained from a standard Kalman filter formulation.

In at least some implementations, the vehicle mass is determined in a separate algorithm and provided as an input used to determine the total force.

In at least some implementations, the method also includes determining a state vector and an error covariance, predicting a next state vector and a next error covariance, determining a residual covariance as a function of the measured longitudinal acceleration and the vehicle mass, and calculating a Kalman filter gain as a function of the error covariance and residual covariance.

In at least some implementations, a method of estimating longitudinal acceleration in a vehicle is based on a measured longitudinal acceleration from a sensor of the vehicle and uses a Kalman filter. The method includes initializing an optimal state vector as

$$\hat{X} ( 0 ) = [ \begin{matrix}{\hat{x}}_{1} ( 0 ) \\ {\hat{x}}_{2} ( 0 )\end{matrix} ]$$

and an error covariance as

$$P ( 0 ) = [ \begin{matrix}1 & 0 \\ 0 & 1\end{matrix} ] ,$$

predicting a next state vector and a next covariance matrix:

$$\hat{X} ( k ) = [ \begin{matrix}{\hat{x}}_{1} ( k ) \\ {\hat{x}}_{2} ( k )\end{matrix} ] = {\underbrace{[ \begin{matrix}1 & 0 \\ 0 & 1\end{matrix} ]}}_{A} [ \begin{matrix}{\hat{x}}_{1} ( k - 1 ) \\ {\hat{x}}_{2} ( k - 1 )\end{matrix} ] and {P}_{k} = {AP}_{k - 1} {A}^{T} + Q ,$$

where Q is a design matrix that represents a process covariance, obtaining a vehicle mass value, obtaining a longitudinal acceleration measurement from a vehicle sensor; determining a measurement vector C=[maₘₑₐₛ(k)−m], and a residual covariance: S=CPₖ₋₁C^{T}+R, where R is a design matrix that represents the measurement covariance, determining a Kalman filter gain as K=Pₖ₋₁C^{T}S⁻¹, determining wheel force (Fₓ) as a function of wheel size and wheel torque, determining total force (Fₜₒₜₐₗ) as a function of the wheel force, force of gravity, an aerodynamic force, and a rolling resistance force, determining a measurement error as ϵ=y−C\hat{X}(k−1)=F_{Total}(k)−C\hat{X}(k−1), where y=F_{Total}(k), updating the error covariance (Pₖ) and the state vector (\hat{X}(k)) as Pₖ=(I−KC)Pₖ₋₁, where I is an identity 2×2 matrix, and \hat{X}(k)=\hat{X}(k−1)+Kϵ, and subtracting an estimated value of the sensor bias \hat{x}₂(k)=â_{bias}(k) from the longitudinal acceleration measurement from the vehicle sensor.

In at least some implementations, the design matrix Q and the design matrix R are both tuned by starting with an identity matrix and then determining a response of an observer and tuning the design matrices as a function of the response.

In at least some implementations, the vehicle mass, powertrain torque, wheel size, aerodynamic force, and a rolling resistance force are inputs provided from external sources.

In at least some implementations, the wheel torque is determined as a function of a powertrain torque and a driveline ratio.

In at least some implementations, the wheel force is a wheel torque divided by a wheel radius, and the wheel torque is determined as a function of the powertrain torque and a driveline ratio.

In at least some implementations, the Kalman filter gain is a 2×1 matrix obtained from a standard Kalman filter formulation.

In at least some implementations, the vehicle mass is determined in a separate algorithm and provided as an input used to determine the total force.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 illustrates a vehicle with various components and systems diagrammatically shown;

FIG. 2 is a diagrammatic view of a control system of the vehicle;

FIG. 3 is a schematic view of an algorithm for determining error in a measured longitudinal acceleration; and

FIG. 4 is a flowchart of a method for determining error in a measured acceleration.

### DETAILED DESCRIPTION

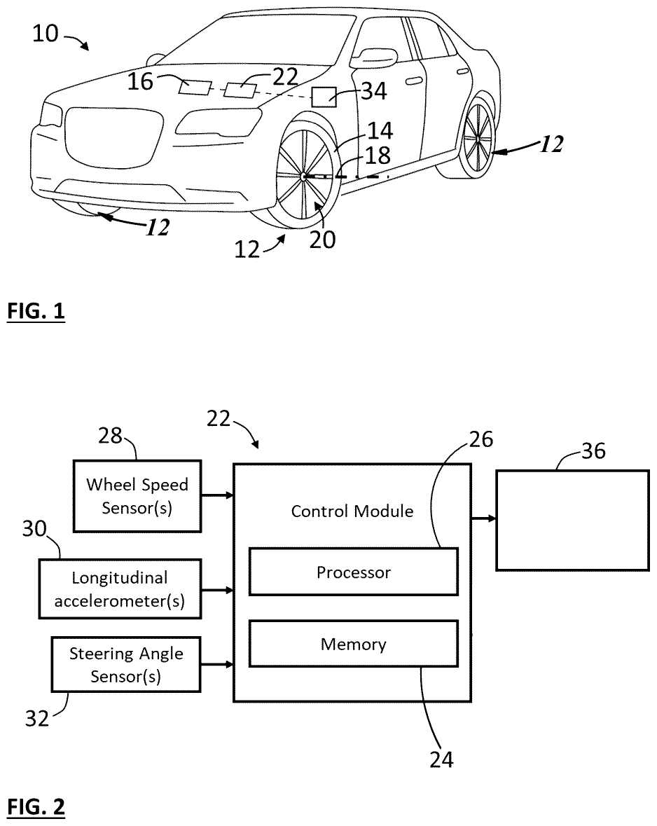

Referring in more detail to the drawings, FIG. 1 illustrates a vehicle 10 that includes multiple wheels 12 with tires 14, and a powertrain system 16 that may include one or both of an electric motor and a combustion engine, and may also include a transmission, via which torque is provided to the wheels 12 to rotate the wheels about axes of rotation 18 and propel the vehicle. The vehicle 10 may also include one or more brakes or brake assemblies 20 to decelerate the vehicle 10 and hold the vehicle stopped. Vehicle speed and acceleration may be determined by one or more wheel speed sensors 28 (FIG. 2) and one or more accelerometers 30. Additionally, steering angle may be determined by one or more steering angle sensors 32. These sensors, among other things, may be communicatively coupled with a controller 22 or control system (e.g., an engine control module). The controller 22 and sensors 28, 30, 32 may be used in control of one or move vehicle functions or systems, like autonomous or partially autonomous vehicle operation, anti-lock brake control, vehicle stability control, traction control, and the like. The controller 22 may include a memory 24 for storing data from the one or more sensors, and instructions or programs, and a processor 26 for processing the data and executing the instructions or programs stored in the memory.

In order to perform the functions and desired processing set forth herein, as well as the computations therefore, the controller 22 may include, but not be limited to, a processor(s), computer(s), DSP(s), memory, storage, register(s), timing, interrupt(s), communication interface(s), and input/output signal interfaces, and the like, as well as combinations comprising at least one of the foregoing. For example, controller 22 may include input signal processing and filtering to enable accurate sampling and conversion or acquisitions of such signals from communications interfaces and sensors. As used herein the terms controller 22 may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality.

The term “memory” 24 or “storage” as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory 24 can store an operating system and/or instructions/programs executable by a processor or controller or the like to enable control or allocate resources of a computing device.

As shown in FIG. 2, to permit measurement of the rotational speed of the wheels 12, the wheel speed sensor 28 may be associated with one of the wheels 12 to provide an output to the controller 22 that is indicative of the rotation of the wheel. By way of a non-limiting example, the wheel speed sensor 28 may be a hall effect sensor with a magnet being rotated with the wheel or spindle and with a sensing element used to detect the magnet as it rotates by the sensing element. Of course, other types of rotational speed sensors may be used.

Additionally, acceleration may be measured using one or more accelerometers 30 which measures gravitational forces (i.e., g-forces) in a longitudinal (e.g. forward-rearward) direction, a lateral (e.g. cross-car) direction, and vertical (e.g. up/down) direction, as well as rotations about longitudinal, lateral and vertical axes. In at least one embodiment, the one or more accelerometers are defined by an Inertial Measurement Unit (IMU) that is a multi-axis accelerometer which provides simultaneous measurement of acceleration in three perpendicular axes and rotational velocities about the axes, for example.

To measure the position of wheels, the steering angle sensor 32 may be associated with one or more of the wheels 12 or with a steering shaft 34 of the vehicle 10. In at least one embodiment, the steering angle sensor may be a giant magnetoresistance (GMR) device, by way of one non-limiting example, that provides an absolute steering angle value over the complete steering angle range. Other types of sensors may be used, for example but not limited to, tunnel magnetoresistance (TMR) sensors and anisotropic magnetoresistance (AMR) sensors. The steering angle sensor 32 may provide an output that permits steering angle and/or steering angle velocity or rate of change of steering angle to be determined at the controller 22.

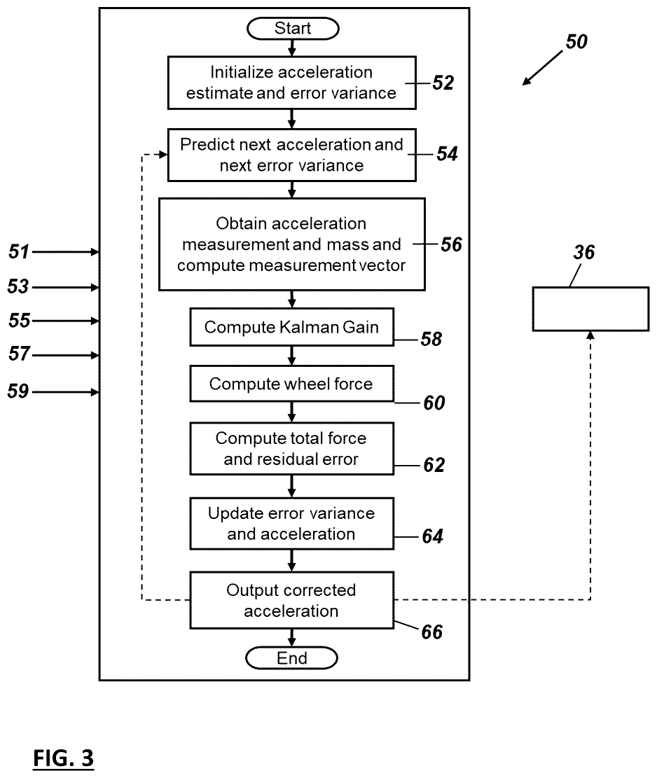

One or more systems 36 (FIGS. 2 and 3) of vehicle 10 may rely on the vehicle acceleration, wheel speed and/or steering angle data from the accelerometer 30 and/or steering angle sensor 32 during operation or during travel of the vehicle 10. Some systems may be on-board the vehicle 10 and some systems may be remote from the vehicle 10. For instance, an anti-lock braking system (ABS), traction control system (TC), electronic stability control system (ESC), on-board diagnostic monitors (OBD), torque security features, cruise control (CC), adaptive cruise control (ACC), acceleration control, and/or autonomous vehicle systems (AVS) may utilize some or all of the data from the accelerometer 30, wheel speed sensors, and/or steering angle sensor 32.

Sensors can have a bias or offset, and can provide noisy output signals/data, whereby output from the sensor is different than the actual value of the parameter detected by the sensor. For example, accelerometers 30 may output data regarding acceleration that is higher than the actual vehicle acceleration, and may, for example, output data indicating some acceleration when the vehicle is not accelerating. This bias or offset can affect performance of systems that utilize the senor outputs, and so it is desirable to determine and remove the sensor bias/offset before using the sensor outputs. For example, the sensor data may be used in feedback or feedforward control schemes and incorrect data can lead to poor or inaccurate control behavior.

While some sensors, including some IMUs 30, can have high levels of precision and low noise, these sensors are expensive, may require pre-calibration and are generally not used in mass production vehicles due to the cost of the sensors. Lower cost IMUs 30, on the other hand, are not well-calibrated and usually their measurements have a relatively high level of noise and bias. Before using low cost IMUs in production vehicles, their output measurements must be processed to account for/remove the noise and the bias. Noise can be handled by various filters, but the bias is more challenging to accurately and quickly determine and remove.

As noted above, sensors including accelerometers 30 often output a nonzero value when they are stationary and should therefore have an output of zero. This value is called static offset. Static offset is predictable, but a different type of offset, called dynamic offset, can vary with temperature, supply voltage, orientation of the sensor, and asymmetrical loading of the vehicle. Dynamic offset cannot be easily predicted.

In at least some implementations, a method/algorithm determines or estimates the dynamic offset of an accelerometer using, among other things, a Kalman filter and the static offset of the sensor is included in the estimation. Kalman filtering (sometimes also known as linear quadratic estimation) is an algorithm that uses a series of measurements observed over time, including statistical noise and other inaccuracies, to produce estimates of unknown variables, rather than estimating based on a single measurement. The Kalman filter can estimate a joint probability distribution over the variables for each time-step, and may be constructed as a mean squared error minimizer.

In general, the Kalman filter works via a two-phase process: a prediction phase and an update phase. In the prediction phase, the Kalman filter produces estimates of the current state variables, including their uncertainties. Once the outcome of the next measurement (necessarily including some error, including noise, bias and sensor offset(s)) is observed, these estimates are updated using a weighted average, with more weight given to estimates with greater certainty. The algorithm is recursive. It can operate in real time, using only the present input measurements and the state calculated previously and its uncertainty matrix; no additional past information is required.

The governing equation of vehicle longitudinal dynamics can be approached according to Newton second law of motion, which is given by:

$$ma = {F}_{Total} ⟹ a = \frac{{F}_{Total}}{m} ,$$

where, F_{Total}=Fₓ−Fₐ−F_{R}−F_{g}. Here, F_{Total} is the net longitudinal forces acting on the vehicle. Fₓ is the force acting on the vehicle tires generated via road-tire interaction, which depends on the torque τ_{w} acting on the wheels and the wheel radius R_{W}. τ_{w} might be obtained directly from another vehicle system or sensor, e.g. available via a CAN bus of the vehicle. If the torque τ_{w} is not available, it can be computed from engine torque and brake torque, as follows:

$${F}_{x} = \frac{{τ}_{w}}{{R}_{W}} .$$

Next, Fₐ is the aerodynamic force, F_{R} is the rolling resistance force, and F_{g} is the gravity force. The forces Fₐ, F_{R}, and Fₐ may be computed from separate algorithms in known manner. Further, m is the vehicle mass, provided as an input, which may be an estimation from an external algorithm, and a is the vehicle acceleration.

The actual acceleration of the vehicle can be written as: a_{actual}=aₘₑₐₛ−a_{bias}; and by substitution,

$$\frac{{F}_{Total}}{m} = {a}_{meas} - {a}_{bias} ,$$

which becomes: F_{Total}=maₘₑₐₛ−ma_{bias}. And this equation can be written as:

$${F}_{Total} = [ {ma}_{meas} - m ] [ \begin{matrix}1 \\ {a}_{bias}\end{matrix} ] .$$

A Kalman filter can be formulated to solve the above problem as below:

$$[ \begin{matrix}{\hat{x}}_{1} ( k ) \\ {\hat{x}}_{2} ( k )\end{matrix} ] = {I}_{2 \times 2} [ \begin{matrix}{\hat{x}}_{1} ( k - 1 ) \\ {\hat{x}}_{2} ( k - 1 )\end{matrix} ] + K [ {F}_{Total} ( k ) - [ {ma}_{meas} - m ] [ \begin{matrix}{\hat{x}}_{1} ( k - 1 ) \\ {\hat{x}}_{2} ( k - 1 )\end{matrix} ] ] .$$

In this equation, \hat{x}₂(k)=â_{bias}(k) is the estimated longitudinal acceleration bias, and K is the Kalman filter gain matrix obtained from a standard Kalman filter formulation, with a 2×1 matrix in this representative algorithm.

The Kalman filter observer formulation can be done in several steps as in the example set forth herein, and with reference to the diagram of FIG. 3 which illustrates a method 50 of determining a vehicle acceleration as a function of a measured acceleration and an estimated error in the measured acceleration. First, in step 52, the optimal state vector

$$\hat{X} ( 0 ) = [ \begin{matrix}{\hat{x}}_{1} ( 0 ) \\ {\hat{x}}_{2} ( 0 )\end{matrix} ]$$

and the error covariance matrix P: is initialized. Initializing the state vector can be random and can be zero. In this example, since \hat{x}₁(k) is constant, the initial value will be its constant value. The initial value of the bias \hat{x}₂(k)=â_{bias}(0) is set to zero. The error covariance matrix P is usually initialized to the identity matrix, which is a 2×2 matrix in this algorithm,

$$P ( 0 ) = [ \begin{matrix}1 & 0 \\ 0 & 1\end{matrix} ] .$$

Next, in step 54, the next state vector and covariance matrix are predicted as follows:

$$\hat{X} ( k ) = [ \begin{matrix}{\hat{x}}_{1} ( k ) \\ {\hat{x}}_{2} ( k )\end{matrix} ] = [ {\underbrace{\begin{matrix}1 & 0 \\ 0 & 1\end{matrix}}}_{A} ] [ \begin{matrix}{\hat{x}}_{1} ( k - 1 ) \\ {\hat{x}}_{2} ( k - 1 )\end{matrix} ] ; and$$

$${P}_{k} = {AP}_{k - 1} {A}^{T} + Q ,$$

where

$$Q = [ \begin{matrix}{q}_{11} & 0 \\ 0 & {q}_{22}\end{matrix} ]$$

is a design matrix that represents the process covariance, which can be a diagonal matrix, q₁₁ represents the variance of \hat{x}₁(k), which is given a very small variance value to tell the filter that this value is not changing because it is constant, q₂₂ represents the variance of the second state â_{bias}(k), which is the accelerometer bias to be estimated with this method.

In step 56, inputs are obtained for vehicle mass 51 (e.g. as estimated from an external algorithm) and a longitudinal acceleration measurement 53 from the IMU (e.g. from the CAN bus). Computations are done for the measurement vector C=[maₘₑₐₛ(k)−m], and then residual covariance: S=CPₖ₋₁C^{T}+R, where R is a design matrix that represents the measurement covariance, which can be and is scalar in this algorithm.

In step 58, the Kalman gain is computed: K=Pₖ₋₁C^{T}S⁻¹. In step 60, the wheel radius and wheel torque are obtained as inputs 55, 57, then wheel force Fₓ is computed:

$${F}_{x} = \frac{{τ}_{w}}{{R}_{W}} .$$

Next, in step 62, the rest of the forces are obtained (e.g. computed externally and input at 59), then the total net force and measurement residual error are computed: F_{Total}=Fₓ−Fₐ−F_{R}−F_{g}; and

$$ϵ = y - C \hat{X} ( k - 1 ) = {F}_{Total} ( k ) - C \hat{X} ( k - 1 ) , where y = {F}_{Total} ( k ) .$$

In step 64, the error covariance Pₖ and estimated vector \hat{X}(k) are updated:

$${P}_{k} = ( I - KC ) {P}_{k - 1} ; where I is the identity 2 \times 2 matrix ; and$$

$$\hat{X} ( k ) = \hat{X} ( k - 1 ) + K ϵ .$$

In step 66, the estimated value of the bias \hat{x}₂(k)=â_{bias}(k) is subtracted from the IMU longitudinal acceleration signal aₘₑₐₛ and the corrected estimate is provided to the vehicle functions that use it, and then the method may return to and repeat from step 54.

In at least some implementations, the choice of the Q and R design matrices can significantly affect the results of the state observer. They are usually tuned by trial and error, and in the method described this may be started by the identity matrices and the response of the observer watched to enable calibration until a satisfactory response is met.

Thus, the longitudinal acceleration can be estimated by the method noted above which utilizes engine torque as an input instead of wheel speed. Wheel speed can be unreliable as the wheels may move (e.g. slip or slide) on and relative to the ground such as, by way of non-limiting examples, during rapid acceleration or hard braking events. During, for example, wheel loss of traction events, the acceleration estimation if based on wheel speed inputs, cannot be relied upon. The engine torque data, however, is more reliable and is not thrown off by loss of traction at the wheels as is the wheel speed, and thus enables more accurate longitudinal acceleration estimation in a wide range of circumstances. Thus, the longitudinal acceleration sensor bias/offset/noise can be reliably estimated and an accurate estimation of the actual, instantaneous longitudinal acceleration can be determined and then provided to various vehicle systems and controllers that rely upon longitudinal acceleration information.

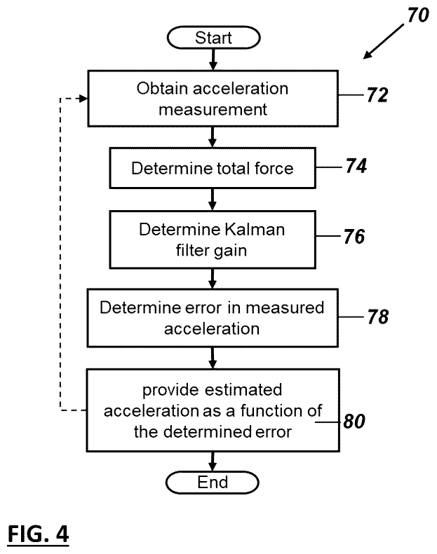

In the method 70 shown in FIG. 4 and with regard to the algorithm and method 50 described above, vehicle mass, powertrain torque, wheel size, aerodynamic force, rolling resistance force, gravitational force, a driveline ratio (shown as input 61 in FIG. 3) and the output from the accelerometer are used as inputs to the algorithm of the method. The algorithm permits determination of instantaneous offset and bias of the accelerometer and adjustment of the measured acceleration to a more accurate, estimated acceleration that is better used in vehicle systems.

In the method 70 of FIG. 4, step 72 includes obtaining a measured acceleration from an accelerometer 30. The method then determines an error in the measured acceleration which includes a bias and a dynamic offset, as noted herein. In step 74, the total force is computed, and this may be done as a function of vehicle mass and powertrain torque, in step 76 a Kalman filter gain is computed and in step 78 an error in the measured longitudinal acceleration is determined as a function of the Kalman filter gain and the total force. Finally, in step 80 an estimated longitudinal acceleration is determined as a function of the measured longitudinal acceleration and the error, and this estimated longitudinal acceleration may be provided to other vehicle systems and algorithms to enable desired control of the vehicle.

What is claimed is:

1. A method for estimating longitudinal acceleration in a vehicle based on a measured longitudinal acceleration from a sensor of the vehicle, comprising:
obtaining a measured longitudinal acceleration from the sensor;
determining a total force as a function of vehicle mass and powertrain torque;
determining a Kalman filter gain;
determining an error in the measured longitudinal acceleration as a function of the Kalman filter gain and the total force; and
providing an estimated longitudinal acceleration as a function of the measured longitudinal acceleration and the error.

2. The method of claim 1 wherein the total force is determined also as a function of a wheel size.

3. The method of claim 1 wherein the powertrain torque is a torque at the vehicle wheels determined as a function of an engine torque and a driveline ratio.

4. The method of claim 1 wherein the total force includes a wheel force which is a longitudinal force from a wheel to a vehicle body, an aerodynamic force, a rolling resistance force and the force of gravity.

5. The method of claim 4 wherein the wheel force is a wheel torque divided by a wheel radius, and the wheel torque is determined as a function of the powertrain torque and a driveline ratio.

6. The method of claim 1 wherein the Kalman filter gain is a 2×1 matrix obtained from a standard Kalman filter formulation.

7. The method of claim 1 wherein the vehicle mass is determined in a separate algorithm and provided as an input used to determine the total force.

8. The method of claim 1 which includes:
determining a state vector and an error covariance;
predicting a next state vector and a next error covariance;
determining a residual covariance as a function of the measured longitudinal acceleration and the vehicle mass; and
calculating a Kalman filter gain as a function of the error covariance and residual covariance.

9. A method of estimating longitudinal acceleration in a vehicle based on a measured longitudinal acceleration from a sensor of the vehicle, comprising:
initializing an optimal state vector as
$$\hat{X} ( 0 ) = [ \begin{matrix}{\hat{x}}_{1} ( 0 ) \\ {\hat{x}}_{2} ( 0 )\end{matrix} ]$$
and an error covariance as
$$P ( 0 ) = [ \begin{matrix}1 & 0 \\ 0 & 1\end{matrix} ] ;$$
predicting a next state vector and a next covariance matrix:
$$\hat{X} ( k ) = [ \begin{matrix}{\hat{x}}_{1} ( k ) \\ {\hat{x}}_{2} ( k )\end{matrix} ] = [ {\underbrace{\begin{matrix}1 & 0 \\ 0 & 1\end{matrix}}}_{A} ] [ \begin{matrix}{\hat{x}}_{1} ( k - 1 ) \\ {\hat{x}}_{2} ( k - 1 )\end{matrix} ] and$$
$${P}_{k} = {AP}_{k - 1} {A}^{T} + Q ,$$
where Q is a design matrix that represents a process covariance;
obtaining a vehicle mass value;
obtaining a longitudinal acceleration measurement from a vehicle sensor; determining a measurement vector C=[maₘₑₐₛ(k)−m], and a residual covariance: S=CPₖ₋₁C^{T}+R, where R is a design matrix that represents the measurement covariance;
determining a Kalman filter gain as K=Pₖ₋₁C^{T}S⁻¹;
determining wheel force (Fₓ) as a function of wheel size and wheel torque;
determining total force (Fₜₒₜₐₗ) as a function of the wheel force, force of gravity, an aerodynamic force, and a rolling resistance force;
determining a measurement error as ϵ=y−C\hat{X}(k−1)=F_{Total}(k)−C\hat{X}(k−1), where y=F_{Total}(k);
updating the error covariance (Pₖ) and the state vector (\hat{X}(k)) as Pₖ=(I−KC)Pₖ₋₁, where I is an identity 2×2 matrix, and \hat{X}(k)=\hat{X}(k−1)+Kϵ; and
subtracting an estimated value of the sensor bias \hat{x}₂(k)=â_{bias}(k) from the longitudinal acceleration measurement from the vehicle sensor.

10. The method of claim 9 wherein the design matrix Q and the design matrix R are both tuned by starting with an identity matrix and then determining a response of an observer and tuning the design matrices as a function of the response.

11. The method of claim 9 wherein the vehicle mass, powertrain torque, wheel size, aerodynamic force, and a rolling resistance force are inputs provided from external sources.

12. The method of claim 9 wherein the wheel torque is determined as a function of a powertrain torque and a driveline ratio.

13. The method of claim 9 wherein the wheel force is a wheel torque divided by a wheel radius, and the wheel torque is determined as a function of the powertrain torque and a driveline ratio.

14. The method of claim 9 wherein the Kalman filter gain is a 2×1 matrix obtained from a standard Kalman filter formulation.

15. The method of claim 9 wherein the vehicle mass is determined in a separate algorithm and provided as an input used to determine the total force.
